(19) United States
(12) Patent Application Publication
(10) Pub. No.: US 2020/0272693 A1
(43) Pub. Date: Aug. 27, 2020

(54) TOPIC BASED SUMMARIZER FOR MEETINGS AND PRESENTATIONS USING HIERARCHICAL AGGLOMERATIVE CLUSTERING

(71) Applicant: Microsoft Technology Licensing, LLC, Redmond, WA (US)

(72) Inventors: Jeet Sunil Mody, Redmond, WA (US); Shalendra Chhabra, Redmond, WA (US); Senthil Kumar Velayutham, Sammamish, WA (US)

(21) Appl. No.: 16/282,141

(22) Filed: Feb. 21, 2019

(51) Int. Cl. G06F 17/27; G06F 16/33; G06F 16/338

(52) U.S. Cl. CPC G06F 17/2785; G06F 16/338; G06F 16/3344

(57) ABSTRACT

Disclosed are systems, methods, and non-transitory computer-readable media for a meeting-topic based summarizer that uses hierarchical agglomerative clustering (HAC). A meeting summarization system generates representative vectors for each statement in a text. Each statement includes one or more terms and each representative vector indicates a relative importance of its respective statement to the text based on the one or more terms included in the respective statement. The meeting summarization system generates vector clusters based on the representative vectors and determines topics of the text based on the statements represented by the representative vectors included in each vector cluster. The meeting summarization system generates a summary of the text based on the determined topics.

### TECHNICAL FIELD

An embodiment of the present subject matter relates generally to data summarization and, more specifically, to a meeting-topic based summarizer that uses hierarchical agglomerative clustering (HAC).

### BACKGROUND

Videoconference systems are commonly used to conduct meetings. One benefit that videoconference systems provide is that the meeting may be recorded and rewatched again if desired. This may be helpful for users that were unable to attend the meeting or for users to refresh on what occurred during the meeting. While helpful, reviewing long meetings is time consuming. A meeting may last multiple hours, making it difficult to find relevant portions. To alleviate this issue, notes, meeting minutes, and/or a meeting summary may be generated to provide some insight into the contents of the meeting. This task, however, is currently performed manually and is time consuming. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data, according to some example embodiments.

FIG. 2, is a block diagram of a meeting summarization system, according to some example embodiments.

FIG. 3 is a block diagram of a topic identification module, according to some example embodiments.

FIG. 4 is a flowchart showing an example method of generating meeting summary, according to certain example embodiments.

FIG. 5 is a flowchart showing an example method of identifying topics for a meeting, according to certain example embodiments.

FIGS. 6A-6D are screenshots of a generated summary of a meeting, according to certain example embodiments.

FIG. 7 is a block diagram illustrating a representative software architecture, which may be used in conjunction with various hardware architectures herein described.

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for a meeting-topic based summarizer that uses hierarchical agglomerative clustering (HAC). A meeting summarization system analyzes a recorded meeting to identify topics discussed during the meeting and generate a summary of the meeting based on the identified topics. To accomplish this, the meeting summarization system initially converts the meeting into a text file. The meeting summarizer identifies individual statements (e.g., sentences, paragraphs, etc.) in the text file and generates representative vectors for the identified statement. The representative vector generated for each statement indicates a determined relative importance of the statement to its given text. That is, the representative vector generated for a given statement indicates how important the statement is to the text from which it was identified. Hence, the representative vector generated for a given statement may be different based on the text from which the statement was identified.

The meeting summarization system may generate the representative vectors based on term frequency-inverse document frequency (tf-idf) values determined based on the individual terms (e.g., words) in each statement. For example, each value of the vector may correspond to the tf-idf value of a term in the statement. Tf-idf is a numerical statistic that reflect how important each term is to a document (e.g., statement) in a collection or corpus (e.g., text). The tf-idf value increases proportionally to the number of times a term appears in the statement and is offset by the number of statements in the text that contain the term, which helps to adjust for the fact that some terms appear more frequently in general.

The meeting summarization system uses a HAC algorithm to cluster the representative vectors into vector clusters. For example, the HAC algorithm uses determined vector distances between the representative vectors to cluster the representative vectors into vector dusters. The meeting summarization system determines the vector distance between two vectors based on a cosine similarity value determined for the two vectors as well as a temporal distance between the statements represented by the representative vectors. The cosine similarity value describes a measure of similarity between two representative vectors based on the angle between the two vectors. The temporal distance between two distances indicates an amount of time that elapsed between occurrence of the statements. The meeting summarization system uses the cosine similarity values and the temporal distances to determine vector distances between the representative vectors, which the HAC algorithm uses to cluster the representative vectors into vector clusters.

Each resulting vector cluster includes a subset of the representative vectors that represent statements from the text that are likely part of the same topic. The meeting summarization system determines the topic(s) for each vector cluster based the terms included in the statements represented by representative vectors in the respective vector cluster. For example, the meeting summarization system ranks the terms based on their tf-idf values to identify the term(s) that contributed to forming the vector cluster.

The meeting summarization system repeats this process based on the resulting vector clusters until each representative vector has been clustered into a single vector cluster. For example, the meeting summarization system determines representative vectors for each vector cluster rather than each statement and clusters the representative vectors based on determined vector distances s. The meeting summarization system then determines topics for the newly generated vector clusters based on the tf-idf values of the term(s) that contributed to forming each vector cluster. By repeating this process, the meeting summarization system determines topic and subtopics for the meeting. The meeting summarization system may then use the identified topics and subtopics to generate a meeting summary for the recorded meeting. For example, the meeting summarization system may generate the summary based on statements and/or terms that have the highest tf-idf values.

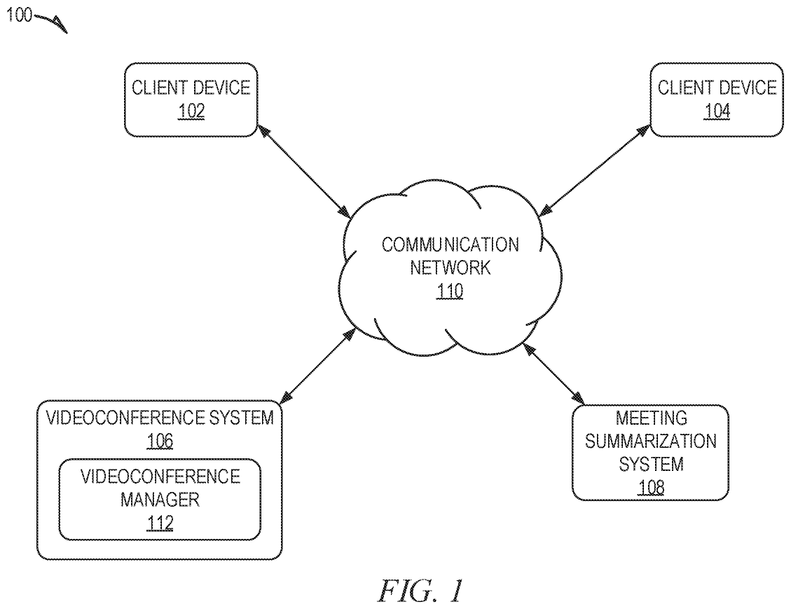

FIG. 1 shows an example system 100, wherein electronic devices communicate via a network for purposes of exchanging content and other data. As shown, multiple devices (i.e., client device 102, client device 104, videoconference system 106, and meeting summarization system 108) are connected to a communication network 110 and configured to communicate with each other through use of the communication network 110. The communication network 110 is any type of network, including a local area network (LAN), such as an intranet, a wide area network (WAN), such as the internet, or any combination thereof. further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

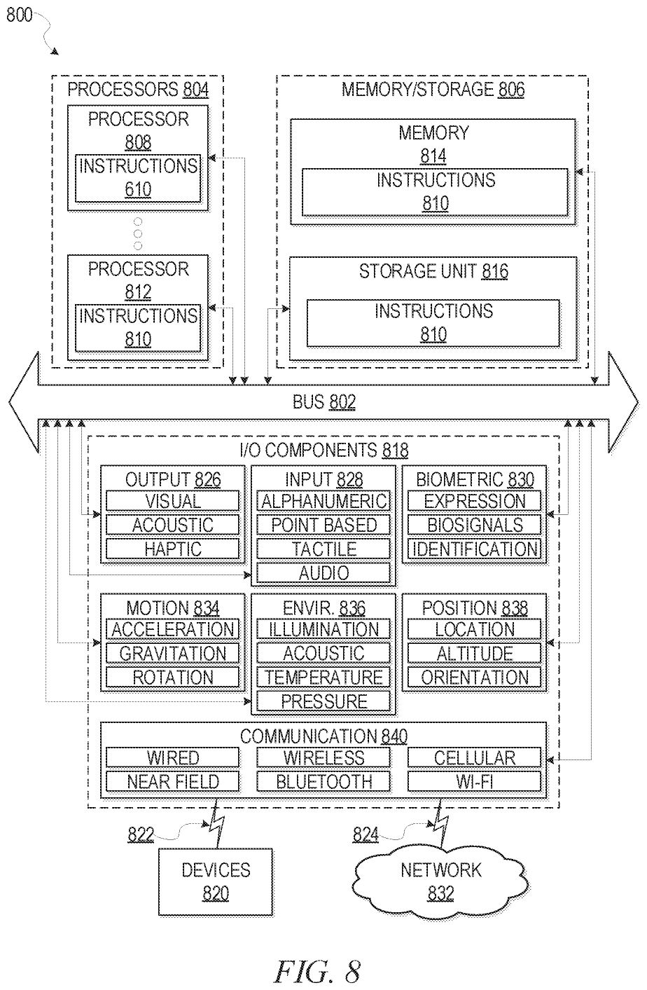

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include sonic or all of the features, components, and peripherals of the machine 800 shown in FIG. 8.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the videoconference system 106 to utilize the services provided by the videoconference system 106. Users communicate with and utilize the functionality of the videoconference system 106 by using the client devices 102 and 104 that are connected to the communication network 110 by direct and/or indirect communication,

Although the shown system 100 includes only two client devices 102, 104, this is only for ease of explanation and is not meant to be limiting. One skilled in the art would appreciate that the system 100 can include any number of client devices 102, 104. Further, the videoconference system 106 may concurrently accept connections from and interact with any number of client devices 102, 104. The videoconference system 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102. and 104 may be of varying type, capabilities, operating systems, and so forth.

A user interacts with the videoconference system 106 via a client-side application installed on the client devices 102 and 104. In some embodiments, the client-side application includes a component specific to the videoconference system 106. For example, the component may be a stand-alone application, one or more application plug-ins, and/or a browser extension. However, the users may also interact with the videoconference system 106 via a third-party application, such as a web browser, that resides on the client devices 102 and 104 and is configured to communicate with the videoconference system 106. In either case, the client-side application presents a user interface (UI) for the user to interact with the videoconference system 106. For example, the user interacts with the videoconference system 106 via a client-side application integrated with the file system or via a webpage displayed using a web browser application.

The videoconference system 106 is one or more computing devices configured to facilitate and manage videoconference meetings between various meeting participants. For example, the videoconference system 106 can facilitate a videoconference between client devices 102 and 104, where a meeting participant using a client device 102 can send and receive audio and/or video with a meeting participant using another client device 104.

To accomplish this, the videoconference system 106 includes a videoconference manager 112 configured to manage a videoconference between multiple client devices 102 104, including initiating the videoconference, identifying the client devices 102, 104 included in the videoconference and sending and receiving videoconference data to and from the various client devices 102, 104 engaged in the videoconference. For example, to manage a videoconference between meeting participants using two client devices 102, 104, the videoconference manager 112 receive videoconference data, including audio data, video data, etc., from one of the client devices 102, and transmit the received videoconference data to the other client device 104, where it can be presented by client device 104, and vice versa. This allows the meeting participants at each client device 102, 104 to receive and share data, including audio and/or video data, thereby enabling the meeting participants to engage in a real time meeting even though the two participants may be in different geographic locations.

The videoconference manager 112 also allows meeting participants to record a meeting, which can be viewed at a later time. For example, the videoconference manager 112 provides a user interface element that a meeting participant may use to select to record a videoconferences. The videoconferences manager 112 stores recorded videoconferences in a data storage along with associated metadata and a unique identifier assigned to the recorded videoconference. An authorized user may access the stored recording from the data storage at a later time to re-watch the meeting.

The videoconference system 106 also provides generated meeting summaries of the recorded videoconferences. A meeting summary identifies topics and subtopics discussed during the meeting, includes key statements from the meeting and may include other metadata such as the meeting participants, times at which various topics and/or subtopics were discussed, etc. The videoconference system 106 uses the functionality of the meeting summarization system 108 to provide the meeting summaries. Although the meeting summarization system 108 and the videoconference system 106 are shown as separate entities, this is just for ease of explanation and is not meant to be limiting. in some embodiments, the meeting summarization system 108 is incorporated as part of the videoconference system 106.

The meeting summarization system 108 is one or more computing device configured to generate a meeting summary for a recorded video conference meeting using hierarchical agglomerative clustering (HAC). The meeting summarization system 108 analyzes a recorded meeting to identify topics discussed during the meeting and generate a meeting summary of the meeting based on the identified topics. To accomplish this, the meeting summarization system 108 initially converts the meeting into a text file. For example, using a text-to-speech conversion algorithm. The meeting summarization system 108 identifies individual statements (e.g., sentences, paragraphs, etc.) in the text file and generates representative vectors for the identified statement. The representative vector generated for each statement indicates a determined relative importance of the statement to its given text. That is, the representative vector generated for a given statement indicates how important the statement is to the text from which it was identified. Hence, the representative vector generated for a given statement may be different based on the text from which the statement was identified.

The meeting summarization system 108 may generate the representative vectors based on term frequency-inverse document frequency (tf-idf) values determined based on the individual terms (e.g., words) in each statement. Tf-idf is a numerical statistic that reflect how important each term is to a document (e.g., statement) in a collection or corpus (e.g., text). The tf-idf value increases proportionally to the number of times a term appears in the statement and is offset by the number of statements in the text that contain the term, which helps to adjust for the fact that some terms appear more frequently in general.

The meeting summarization system 108 uses a HAC algorithm to cluster the representative vectors into vector clusters. The HAC algorithm uses determined cosine similarity values that describe the measure of similarity between two representative vectors and temporal distances that indicate an amount of time that elapsed between occurrence of the statements to determine vector distances between the representative vectors. The HAC algorithm uses the determined vector distances between the representative vectors to cluster the representative vectors into vector clusters.

Each resulting vector cluster includes a subset of the representative vectors that represent statements from the text that are likely part of the same topic. The meeting summarization system 108 determines the topic(s) for each vector cluster based the terms included in the statements represented by representative vectors in the respective vector duster. For example, the meeting summarization system 108 ranks the terms based on their tf-idf values to identify the term(s) that contributed to forming the vector cluster. The terms ranked highest are determined to represent a topic or subtopic discussed during the teleconference meeting.

The meeting summarization system 108 repeats this process based on the resulting vector clusters until each representative vector has been clustered into a single vector cluster. For example, the meeting summarization system 108 determines representative vectors for each vector cluster rather than each statement and the clusters the representative vectors based on determined vector distances. The meeting summarization system 108 then determines topics for the newly generated vector clusters based on the tf-idf values of the term(s) that contributed to forming each vector cluster. By repeating this process, the meeting summarization system 108 determines topic and subtopics for the meeting as whole. The meeting summarization system 108 may then use the identified topics and subtopics to generate the meeting summary for the recorded meeting. For example, the meeting summarization system 108 generates the summary based on statements and/or terms that have the highest tf-idf values.

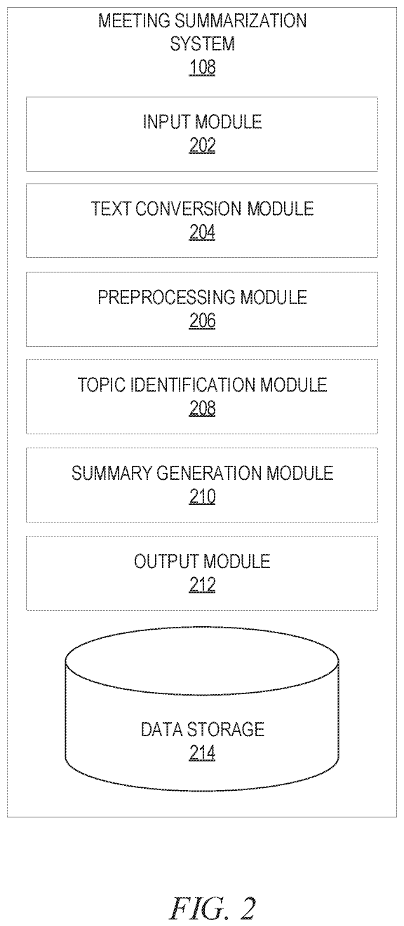

FIG. 2 is a block diagram of a meeting summarization system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the meeting summarization system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the meeting summarization system 108 and the videoconference system 106.

As shown, the meeting summarization system 108 includes an input module 202, a text conversion module 204, a preprocessing module 206, a topic identification module 208, a summary generation module 210, an output module 212, and a data storage 214.

The input module 202 accesses a recording of a teleconference meeting. The input module 202 may access the recording from the videoconference system 106. For example, the input module 202. may transmit a request to the videoconference system 106 that includes the unique identifier for the recording of the teleconference meeting, causing the videoconference system 106 to return the requested recording. As another example, the videoconference system 106 may transmit the recording to the meeting summarization system 108 as part of a request to have a meeting summary generated for the videoconference meeting. The input module 202 receives the recording transmitted from the videoconference system 106.

In some embodiments, the input module 202 access the recording of the videoconferences meeting from the data storage 214. For example, in implementations where the meeting summarization system 108 is incorporates as part of the videoconference system 106, the videoconference manager 112 may store recording of the teleconference meetings in the data storage 214. Accordingly, the input module 202 may access the recordings directly from the data storage 214.

The text conversion module 204 converts a recording of a videoconference meeting into a text file. The text conversion module 204 may use any known text conversion technique to generate the text file. The resulting text file may include written text of the conversations captured between meeting participants during the videoconference meeting. The text file may also include additional metadata, such as data identifying the meeting participants that are speaking, times at which the terms are spoken, etc.

The preprocessing module 206 preprocesses the generated text file to in analyzing the text file, identifying topics from the text file, and ultimately generating a meeting summary. For example, the preprocessing module 206 preprocesses the text file to remove terms that have little or no value towards the meaning of the text. For example, commonly used terms such as ‘the’, ‘a’, etc., that are commonly used in most conversations provide no valuable insight regarding the topic of the conversation. The preprocessing module 206 also performs normalization of the terms in the text through lemmatization (e.g., removing inflection endings). As a result, the base form of the terms remain in the text. As another example, the preprocessing module 206 may also co-reference pronouns in the text. This process identifies the terms in the text that each pronoun is referring to and replaces the pronoun with its corresponding identified term. In addition to normalizing the text, the preprocessing module 206 also performs diarization to partition the text based on the identity of the speaker. The preprocessing module 206 provides the processed text file to the topic identification module 208.

The topic identification module 208 identifies topics and subtopics discussed during the video conference meeting from the text file received from the preprocessing module 206. To accomplish this, the topic identification module 208 identifies statements within the text and generates vector representations of each statement. The topic identification module 208 then uses an HAC algorithm to cluster the vector representations into vector clusters. The HAC algorithm clusters the representative vectors based on determined vector distances. Each vector distance is determined based on a combination of a cosine similarity value and temporal distance for two representative vectors.

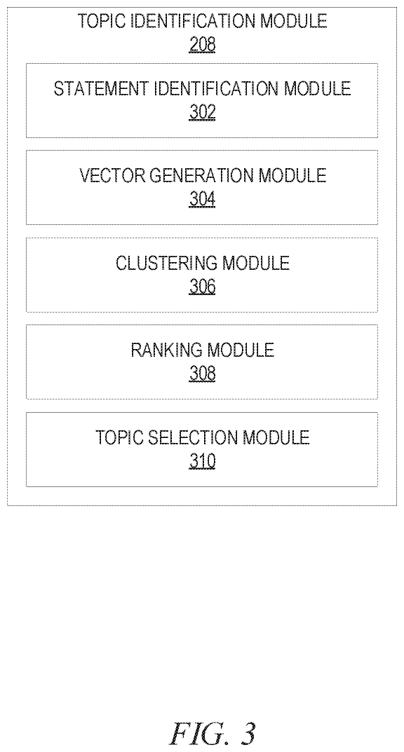

Each vector cluster include statements that are likely to pertain to the same topic or topics, The topic identification module 208 ranks the terms in each vector cluster to determine the topic of the corresponding vector cluster. For example, the topic identification module 208 ranks the terms based on tf-idf values determined for each term to identify the terms that contributed to forming the vector cluster. The terms ranked highest are determined to represent a topic or subtopic discussed by the statements included in the vector cluster. The topic identification module 208 repeats this process based on the resulting vector clusters until each representative vector has been clustered into a single vector cluster. By repeating this process, the topic identification module 208 determines topic and subtopics for the meeting as whole. The functionality of the topic identification module 208 is described in greater detail in relation to FIG. 3.

The summary generation module 210 generates a meeting summary based on the topics and subtopics identified by the topic identification module 208 for the videoconference meeting. For example, the summary generation module 210 generates the summary based on statements and/or words that have the highest tf-idf values that correspond to each topic. Further, the summary generation module 210 may include additional metadata regarding the times at which each topic was discussed, the meeting participants that played major roles in discussing each topic, etc. The resulting meeting summary may present a list of the topics discussed during the meeting along with statement determined to be relevant (e.g., have a high tf-idf value) to each topic. The topics may be presented according to the chronological order in which the topics were discussed during the meeting. Further, the topics may be presented along with data identifying times during the meeting at which each topic was presented. In some embodiments, the topics may be presented along with links that cause the recording of the meeting to be forwarded to the portion of the meeting during which the respective topic is discussed. A user may read the meeting summary to determine what was discussed as well as select to view any relevant portions.

In some embodiments, the output module 212 may use metadata gathered from previously generated meeting summaries for related meetings when generating the meeting summary. For example, a meeting may be related to a prior meeting based on the meetings including the same meeting participants, including the same meeting title, or being a part of a recurring meeting. In these types of situations, the output module 212 may use metadata associated with the related meeting in generating the meeting summary for the new meeting.

The output module 212 stores the generated meeting summary in the data storage 214, where it is associated with its corresponding recording and accessible to authorized users. The output module 212 may also provide the generated meeting summary to a requesting users client device 102.

FIG. 3 is a block diagram of a topic identification module 208, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the topic identification module 208 to facilitate additional functionality that is not specifically described herein. Furthermore, the various functional modules depicted in FIG. 3 may reside on a single computing device or may be distributed across several computing devices in various arrangements such as those used in cloud-based architectures. For example, the various functional modules and components may be distributed amongst computing devices that facilitate both the meeting summarization system 108 and the videoconference system 106.

As shown, the topic identification module 208 includes a statement identification module 302, a vector generation module 304, a clustering module 306, a ranking module 308, and a topic selection module 310.

The statement identification module 302 identifies statements in a provided text. A statement may include any type of grouping of terms in the text. For example, the statement may be a sentence, paragraph, etc. As another example, a statement may be terms spoken by a single person during a predetermined time period or without a break that exceeds a threshold. The statement identification module 302 analyzes the text and corresponding metadata to identify the statements in the text. For example, the statement identification module 302 may use timestamp data to identify pauses in the text that indicate the beginning and/or ending of a statement. As anther example, the statement identification module 302 identifies punctuation in the text, such as capitalized words, periods, etc., that indicate the beginning and/or ending of a statement.

The vector generation module 304 generates representative vectors for each statement identified from the text. The representative vector generated for each statement indicates a determined relative importance of the statement to its given text. That is, the representative vector generated for a given statement indicates how important the statement is to the text from which it was identified. Hence, the representative vector generated for a given statement may be different based on the text from which the statement was identified.

The vector generation module 304 generates the representative vectors based on term frequency-inverse document frequency (tf-idf) values determined based on the individual terms (e.g., words) in each statement. Tf-idf is a numerical statistic that reflect how important each term is to a document (e.g., statement) in a collection or corpus (e.g., text). The tf-idf value increases proportionally to the number of times a term appears in the statement and is offset by the number of statements in the text that contain the term, which helps to adjust for the fact that some terms appear more frequently in general.

The clustering module 306 uses a HAC algorithm to cluster the representative vectors into vector clusters. For example, the HAC algorithm uses determined vector distances between the representative vectors to cluster the representative vectors into vector clusters. The vector distance between two vectors is based on a cosine similarity value determined for the two vectors as well as a temporal distance between the statements represented by the representative vectors. The cosine similarity value describes a measure of similarity between two representative vectors based on the angle between the two vectors. The temporal distance between two distances indicates an amount of time that elapsed between occurrence of the statements. Each resulting vector cluster includes a subset of the representative vectors that represent statements from the text that are likely part of the same topic.

The ranking module 308 ranks the terms in each vector cluster based on the respective tf-idf values of the terms. Ranking the words identifies the term(s) that contributed to forming the vector cluster. The terms ranked highest are determined to have contributed the greatest to forming the vector cluster.

The topic selection module 310 selects a topic for each vector cluster based on the ranking of the terms in the statements represented by the respective vector cluster. The terms ranked highest are determined to represent a topic or subtopic discussed by the statements included in the vector cluster. Accordingly, the topic selection module 310 selects the terms that are ranked the highest.

The topic identification module 208 repeats the above described functionality based on the resulting vector clusters until each representative vector has been clustered into a single vector cluster. For example, the vector generation module 304 determines representative vectors for each vector cluster rather than each statement and the clustering module 306 clusters the representative vectors based on determined vector distances. The ranking module then ranks the terms in the newly generated vector clusters based on the tf-idf values of the term(s) that contributed to forming each vector cluster, after which the topic selection module 310 selects topics and subtopics based on the ranking. By repeating this process, the topic identification module 208 determines topic and subtopics for the meeting as whole.

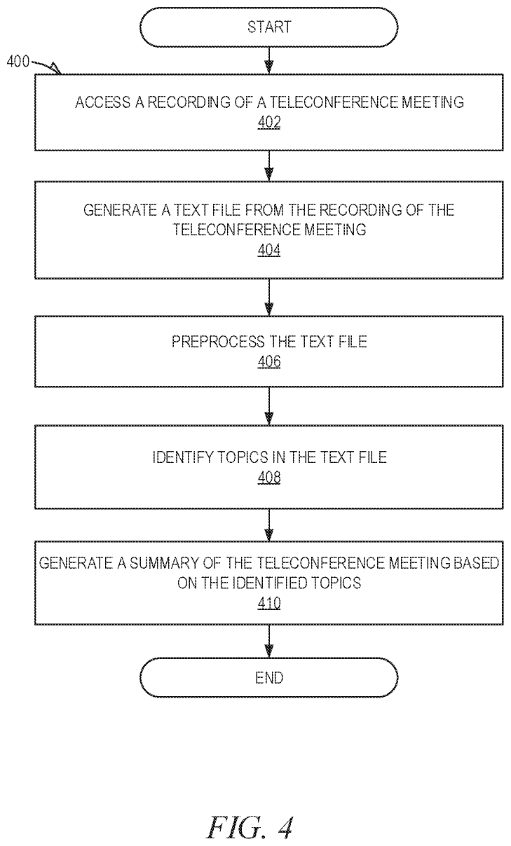

FIG. 4 is a flowchart showing an example method 400 of generating meeting summary, according to certain example embodiments. The method 400 may be embodied in computer readable instructions for execution by one or more processors such that the operations of the method 400 may be performed in part or in whole by the meeting summarization system 108; accordingly, the method 400 is described below by way of example with reference thereto. However, it shall be appreciated that at least some of the operations of the method 400 may be deployed on various other hardware configurations and the method 400 is not intended to be limited to the meeting summarization system 108.

At operation 402, the input module 202 accesses a recording of a teleconference meeting. The input module 202 may access the recording from the videoconference system 106. For example, the input module 202 may transmit a request to the videoconference system 106 that includes the unique identifier for the recording of the teleconference meeting, causing the videoconference system 106 to return the requested recording. As another example, the videoconference system 106 may transmit the recording to the meeting summarization system 108 as part of a request to have a meeting summary generated for the videoconference meeting. The input module 202 receives the recording transmitted from the videoconference system 106.

In some embodiments, the input module 202 access the recording of the videoconferences meeting from the data storage 214. For example, in implementations where the meeting summarization system 108 is incorporates as part of the videoconference system 106, the videoconference manager 112 may store recording of the teleconference meetings in the data storage 214. Accordingly, the input module 202 may access the recordings directly from the data storage 214.

At operation 404, the text conversion module 204 generates a text file from the recording of the teleconference meeting. The text conversion module 204 may use any known text conversion technique to generate the text file. The resulting text file may include written text of the conversations captured between meeting participants during the videoconference meeting. The text file may also include additional metadata, such as data identifying the meeting participants that are speaking, times at which the terms are spoken, etc.

At operation 406, the preprocessing module 206 preprocesses the text file. The preprocessing module 206 preprocesses the generated text file to aide in analyzing the text file, identifying topics from the text file, and ultimately generating a meeting summary. For example, the preprocessing module 206 preprocesses the text file to remove terms that have little or no value towards the meaning of the text. For example, commonly used terms such as ‘the’, ‘a’, etc., that are commonly used in most conversations provide no valuable insight regarding the topic of the conversation. The preprocessing module 206 also performs normalization of the terms in the text through lemmatization (e.g., removing inflection endings). As a result, the base form of the terms remain in the text. As another example, the preprocessing module 206 may also co-reference pronouns in the text. This process identifies the terms in the text that each pronoun is referring to and replaces the pronoun with its corresponding identified term. In addition to normalizing the text, the preprocessing module 206 also performs diarization to partition the text based on the identity of the speaker.

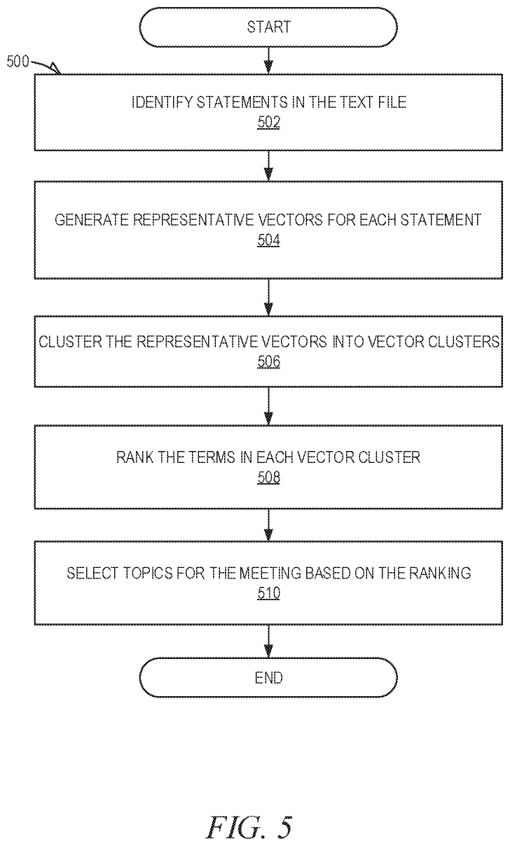

At operation 408, the topic identification module 208 identifies topics in the text file. The topic identification module 208 identifies topics and subtopics discussed during the video conference meeting from the text file received from the preprocessing module 206. To accomplish this, the topic identification module 208 identifies statements within the text and generates vector representations of each statement. The topic identification module 208 then uses an HAC algorithm to cluster the vector representations into vector clusters based on vector distances determined for the representative vectors. Each vector cluster include statements that are likely to pertain to the same topic or topics. The topic identification module 208 ranks the terms in each vector cluster to determine the topic of the corresponding vector cluster. For example, the topic identification module 208 ranks the terms based on tf-idf values determined for each term to identify the terms that contributed to forming the vector cluster. The terms ranked highest are determined to represent a topic or subtopic discussed by the statements included in the vector cluster. The topic identification module 208 repeats this process based on the resulting vector clusters until each representative vector has been clustered into a single vector cluster. By repeating this process, the topic identification module 208 determines topic and subtopics for the meeting as whole. This operation is described in greater detail in relation to FIG. 5.

At operation 410, the summary generation module 210 generates a summary of the teleconferences meeting based on the identified topics. For example, the summary generation module 210 generates the summary based on statements and/or words that have the highest tf-idf values that correspond to each topic. Further, the summary generation module 210 may include additional metadata regarding the times at which each topic was discussed, the meeting participants that played major roles in discussing each topic, etc.

FIG. 5 is a flowchart showing an example method 500 of identifying topics for a meeting, according to certain example embodiments. The method 500 may be embodied in computer readable instructions for execution by one or more processors such that the operations of the method 500 may be performed in part or in whole by the meeting summarization system 108; accordingly, the method 500 is described below by way of example with reference thereto. However, it shall be appreciated that at least some of the operations of the method 500 may be deployed on various other hardware configurations and the method 500 is not intended to be limited to the meeting summarization system 108.

At operation 502, the statement identification module 302 identifies statements in a text file. A statement may include any type of grouping of terms in the text, For example, the statement may be a sentence, paragraph, etc. As another example, a statement may be terms spoken by a single person during a predetermined time period or without a break that exceeds a threshold. The statement identification module 302 analyzes the text and corresponding metadata to identify the statements in the text. For example, the statement identification module 302. may use timestamp data to identify pauses in the text that indicate the beginning and/or ending of a statement. As anther example, the statement identification module 302 identifies punctuation in the text, such as capitalized words, periods, etc., that indicate the beginning and/or ending of a statement.

At operation 504, the vector clustering module 304 generates representative vectors for each statement. The representative vector generated for each statement indicates a determined relative importance of the statement to its given text. That is, the representative vector generated for a given statement indicates how important the statement is to the text from which it was identified. Hence, the representative vector generated for a given statement may be different based on the text from which the statement was identified.

The vector generation module 304 generates the representative vectors based on term frequency-inverse document frequency (tf-idf) values determined based on the individual terms (e.g., words) in each statement, Tf-idf is a numerical statistic that reflect how important each term is to a document (e.g., statement) in a collection or corpus (e.g., text). The tf-idf value increases proportionally to the number of times a term appears in the statement and is offset by the number of statements in the text that contain the term, which helps to adjust for the fact that some terms appear more frequently in general.

At operation 506, the clustering module 306 clusters the representative vectors into vector clusters. The clustering module 306 uses a HAC algorithm to cluster the representative vectors into vector clusters. For example, the HAC algorithm uses determined vector distances between the representative vectors to cluster the representative vectors into vector clusters. The vector distance between two vectors is based on a cosine similarity value determined for the two vectors as well as a temporal distance between the statements represented by the representative vectors. The cosine similarity value describes a measure of similarity between two representative vectors based on the angle between the two vectors. The temporal distance between two distances indicates an amount of time that elapsed between occurrence of the statements. Each resulting vector cluster includes a subset of the representative vectors that represent statements from the text that are likely part of the same topic.

At operation 508, the ranking module 308 ranks the terms in each vector cluster. The ranking module 308 ranks the terms in each vector cluster based on the respective tf-idf values of the terms. Ranking the words identifies the term(s) that contributed to forming the vector cluster. The terms ranked highest are determined to have contributed the greatest to forming the vector cluster.

At operation 510, the topic selection module 310 selects topics for the meeting based on the ranking. The terms ranked highest are determined to represent a topic or subtopic discussed by the statements included in the vector cluster. Accordingly, the topic selection module 310 selects the terms that are ranked the highest.

The method 500 may be partially repeated based on the resulting vector clusters until each representative vector has been clustered into a single vector cluster. For example, operation 504 is performed again to determine representative vectors for each vector cluster rather than each statement. Likewise, operation 506 is performed again to cluster the representative vectors based on determined vector distances, and operations 508 and 510 are repeated to rank the terms in the newly generated vector clusters based on the tf-idf values of the term(s) that contributed to forming each vector cluster and select topics and subtopics based on the ranking. By repeating this portion of the method 500, topics and subtopics are determined for the meeting as whole.

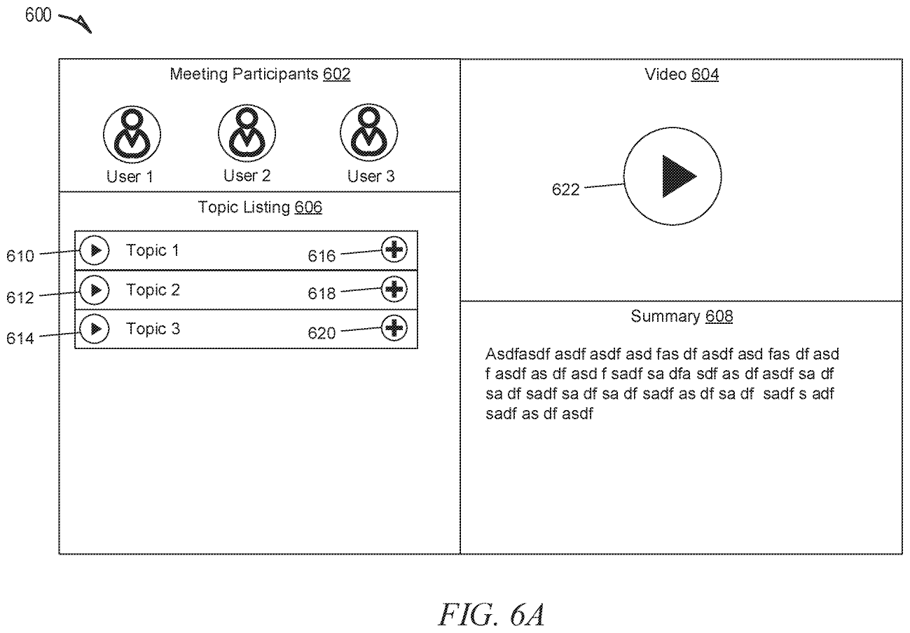

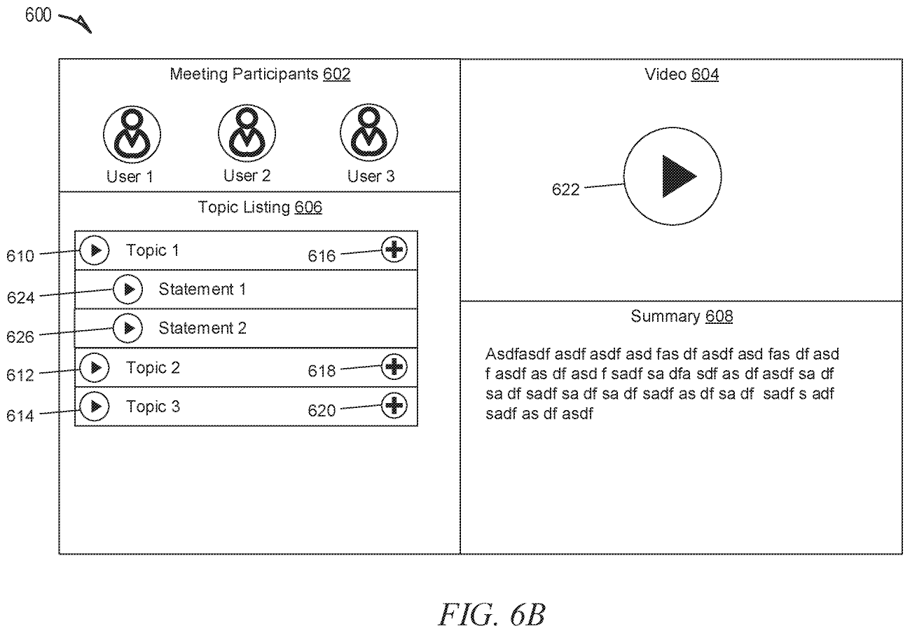

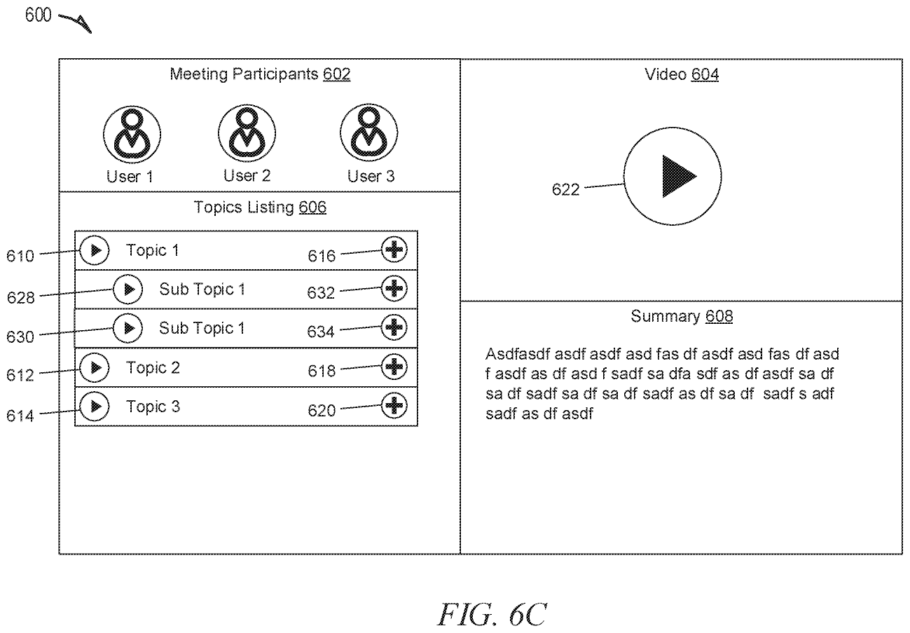

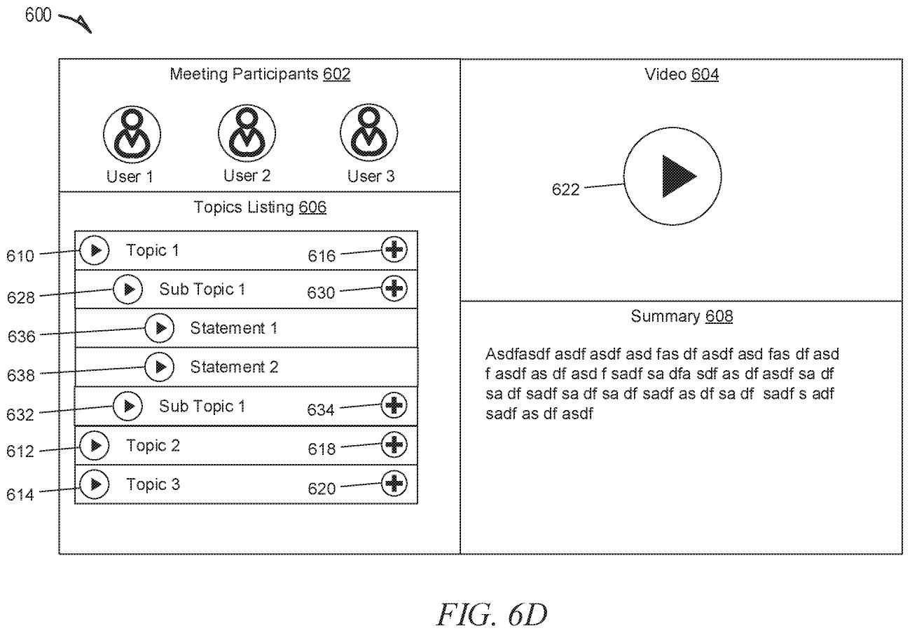

FIGS. 6A-6D are screenshots of a generated summary 600 of a meeting, according to certain example embodiments. As shown in FIG. 6A, the summary 600 includes a meeting participant section 602, a video section 604, a topic listing section 606, and a summary section 608. The meeting participant section 602 identifies the users that participated in the recorded meeting. For example, as shown, user 1, user 2, and user 3 attending the recorded meeting. The video section 604 provides for playback of the recorded meeting. For example, a user may select the play button 622 to cause a video of the recorded meeting to be displayed in the video section 604. The summary section 608 includes a summary of the recorded meeting. The summary describes the meeting and may include statements identified from the recording of the meeting that are determined to be highly relevant to the meeting.

The topic listing section 606 includes a listing of the topics determined to have been discussed during the meeting. As shown, the topic listing section 606 lists three topics: topic 1, topic 2, and topic 3, that were discussed during the meeting. The topics may be listed in an order based on how important, central, and/or relevant the topic was to the meeting or based on the chronological in which the topics were discussed.

As shown, each topic is presented along with a user interface element 610, 612, 614 that is selectable to cause playback of a portion of the recorded meeting that relates to its corresponding topic. For example, a user can actuate (e.g., click) the user interface element 610 corresponding to topic 1 to cause playback of the portion of the recorded meeting that relates to topic 1. The playback can be performed in the video portion of the meeting summary 600. Likewise, a user can actuate the user interface elements 612 or 614 corresponding to topics 2 and 3 to cause playback of the portions of the recorded meeting that relate to topics 2 and 3.

Each topic is also presented along with an expansion button 616, 618, 620 that allows a user to view additional details about the listed topic. For example, a user may actuate the expansion button 616 corresponding to topic 1 to view more information about topic 1. Likewise, the user may actuate the expansion buttons 618, 620 corresponding to topic 2 and topic 3 to view more information about topic 2 and topic 3.

FIG. 6B shows an example embodiment of the summary 600 resulting from a user selecting the expansion button 616 corresponding to topic 1. As shown, selection of the expansion button 616 causes two statements corresponding to topic 1 to be listed in the topic listing section 606. Each listed statement may be a statement that was determined to be highly relevant to determination of the topic from the meeting. In some embodiments, the summary section 608 may be updated based on the user's selection of the expansion button 616 corresponding to topic 1. For example, the summary section 606 may be updated to include a summary that is focused on topic 1 and including statements that relate to topic 1.

Each listed statement is presented along with a user interface element 624, 626 that is selectable to cause presentation of the corresponding portion of the recorded meeting. For example, selection of the user interface element 624 corresponding to statement 1 causes presentation of the portion of the recorded meeting during which statement 1 was spoken by the meeting participants. Likewise, selection of the user interface element 626 corresponding to statement 2 causes presentation of the portion of the recorded meeting during which statement 2 was spoken by the meeting participants.

FIG. 6C shows another example embodiment of the summary 600 resulting from a user selecting the expansion button 616 corresponding to topic 1. As shown, selection of the expansion button 616 causes two subtopics corresponding to topic 1 to be listed in the topic listing section 606. Each listed subtopic is presented along with a user interface element 628, 630 that is selectable to cause presentation of the corresponding portion of the recorded meeting as well as an expansion button 632, 634 to view additional details about the listed subtopic.

In some embodiments, the summary section 608 may be updated based on the user's selection of the expansion button 616 corresponding to topic 1. For example, the summary section 606 may be updated to include a summary that is focused on topic 1 and including statements that relate to topic 1.

FIG. 6D shows an example embodiment of the summary 600 resulting from a user selecting the expansion button 630 corresponding to subtopic 1. As shown, selection of the expansion button 630 causes two statements corresponding to subtopic 1 to be listed in the topic listing section 606. Each listed statement may be a statement that was determined to be highly relevant to determination of the subtopic from the meeting. Each listed statement is presented along with a user interface element 636, 638 that is selectable to cause presentation of the corresponding portion of the recorded meeting. For example, selection of the user interface element 636 corresponding to statement 1 causes presentation of the portion of the recorded meeting during which statement 1 was spoken by the meeting participants. Likewise, selection of the user interface element 638 corresponding to statement 2 causes presentation of the portion of the recorded meeting during which statement 2 was spoken by the meeting participants.

In some embodiments, the summary section 608 may be updated based on the user's selection of the expansion button 630 corresponding to subtopic 1. For example, the summary section 606 may be updated to include a summary that is focused on subtopic 1 and including statements that relate to subtopic 1,

### Software Architecture

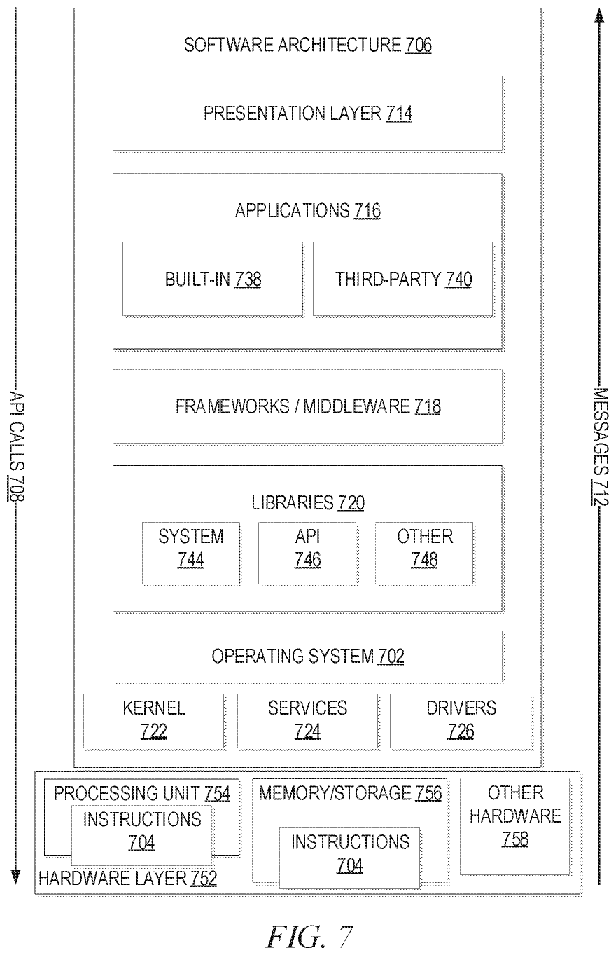

FIG. 7 is a block diagram illustrating an example software architecture 706, which may be used in conjunction with various hardware architectures herein described. FIG. 7 is a non-limiting example of a software architecture 706 and it will be appreciated that many other architectures may be implemented to facilitate the functionality described herein. The software architecture 706 may execute on hardware such as machine 800 of FIG. 8 that includes, among other things, processors 804, memory 814, and (input/output) I/O components 818. A representative hardware layer 752 is illustrated and can represent, for example, the machine 800 of FIG. 8. The representative hardware layer 752 includes a processing unit 754 having associated executable instructions 704. Executable instructions 704 represent the executable instructions of the software architecture 706, including implementation of the methods, components, and so forth described herein. The hardware layer 752 also includes memory and/or storage modules 756, which also have executable instructions 704. The hardware layer 752 may also comprise other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke application programming interface (API) calls 708 through the software stack and receive a response such as messages 712 in response to the API calls 708. The layers illustrated are representative in nature and not all software architectures have all layers. For example, some mobile or special purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 720 provide a common infrastructure that is used by the applications 716 and/or other components and/or layers. The libraries 720 provide functionality that allows other software components to perform tasks in an easier fashion than to interface directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media format such as MPEG4, H 264, MP3. AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks/middleware 718 (also sometimes referred to as middleware) provide a higher-level common infrastructure that may be used by the applications 716 and/or other software components/modules. For example, the frameworks/middleware 718 may provide various graphical user interface (GUI) functions, high-level resource management, high-level location services, and so forth. The frameworks/middleware 718 may provide a broad spectrum of other APIs that may be used by the applications 716 and/or other software components/modules, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. Third-party applications 740 may include an application developed using the ANDROID™ r IOS™ software development kit (SDK) by an entity other than the vendor of the particular platform, and may be mobile software running on a mobile operating system such as IOS™, ANDROID™, WINDOWS® Phone, or other mobile operating systems. The third-party applications 740 may invoke the API calls 708 provided by the mobile operating system (such as operating system 702) to facilitate functionality described herein.

The applications 716 may use built in operating system functions (e.g., kernel 722, services 724, and/or drivers 726), libraries 720, and frameworks/middleware 718 to create Tits to interact with users of the system. Alternatively, or additionally, in some systems, interactions with a user may occur through a presentation layer, such as presentation layer 714. In these systems, the application/component “logic” can be separated from the aspects of the application/component that interact with a user.

FIG. 8 is a block diagram illustrating components of a machine 800, according to some example embodiments, able to read instructions 704 from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 800 capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. in various example embodiments, the I/O components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the 10 components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via. coupling 824 and coupling 822, respectively. For example, the communication components 840 may include a network interface component or other suitable device to interface with the network 832. In further examples, communication components 840 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 810 for execution by the machine 800, and includes digital or analog communications signals or other intangible medium to facilitate communication of such instructions 810. Instructions 810 may be transmitted or received over the network 832 using a transmission medium via a network interface device and using any one of a number of well-known transfer protocols.

“CLIENT DEVICE” in this context refers to any machine 800 that interfaces to a communications network 832 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 832.

“COMMUNICATIONS NETWORK” in this context refers to one or more portions of a network 832 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 832 or a portion of a network 832 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 810 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 810. The term “machine-readable medium” shall also be taken to include any medium, or combination of multiple media, that is capable of storing instructions 810 (e.g., code) for execution by a machine 800, such that the instructions 810, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 804) may be configured by software (e.g., an application 716 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations, For example, a hardware component may include software executed by a general-purpose processor 804 or other programmable processor 804. Once configured by such software, hardware components become specific machines 800 (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time, For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor or processors 804, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 802) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least some of the operations may be performed by a group of computers (as examples of machines 800 including processors 804), with these operations being accessible via a network 832 (e.g., the Internet) and via one or more appropriate interfaces (e.g., an API). The performance of certain of the operations may be distributed among the processors 804, not only residing within a single machine 800, but deployed across a number of machines 800. In some example embodiments, the processors 804 or processor-implemented components may be located in a single geographic location (e.g., within a home environment, an office environment, or a server farm). In other example embodiments, the processors 804 or processor-implemented components may be distributed across a number of geographic locations.

“PROCESSOR” in this context refers to any circuit or virtual circuit (a physical circuit emulated by logic executing on an actual processor 804) that manipulates data values according to control signals (e.g., “commands,” “op codes,” “machine code,” etc.) and which produces corresponding output signals that are applied to operate a machine 800. A processor 804 may be, for example, a central processing unit (CPU), a reduced instruction set computing (RISC) processor, a complex instruction set computing (CISC) processor, a graphics processing unit ((GPU), a digital signal processor (DSP), an ASIC, a radio-frequency integrated circuit (RFIC) or any combination thereof. A processor 804 may further be a multi-core processor having two or more independent processors 804 (sometimes referred to as “cores”) that may execute instructions 810 contemporaneously.

What is claimed is:

1. A method comprising:
generating a representative vector for each statement from a set of statements in a text, yielding a set of representative vectors for the text, wherein each statementincludes one or more terms and each representative vector indicates a relative importance of its respective statement to the text based on the one or more terms included in the respective statement;
generating, based on the representative vectors in the set of representative vectors, at least a first vector cluster and a second vector cluster, the first vector cluster including a first subset of representative vectors from the set of representative vectors and the second vector cluster including a second subset of representative vectors from the set of representative vectors, wherein the first subset of the representative vectors includes at least one representative vector that is not included in the second subset of representative vectors;
determining, based on statements represented by the first subset of representative vectors included in the first vector cluster, a first topic of the text;
determining, based on statements represented by the second subset of representative vectors included in the second vector cluster, a second topic of the text; and
generating a summary of the text based on the first topic and the second topic.

2. The method of claim 1, wherein generating the representative vector for each statement comprises:
determining a term frequency-inverse document frequency (tf-idf) value based on the one or more terms included in the respective statement; and
generating the representative vector based on the tf-idf value.

3. The method of claim 1, wherein determining the first topic comprises:
ranking the first subset of representative vectors based on respective tf-idf values corresponding to each representative vector in the first subset of representative vectors;
selecting a first representative vector from the first subset of representative vectors based on the ranking; and
determining the first topic based on the respective statement corresponding to the first representative vector.

4. The method of claim wherein generating the first vector cluster comprises:
determining a vector distance between at least a first representative vector and a second representative vector, the vector distance determined based on a cosine similarity value indicating a determined distance between the first representative vector and the second representative vector and a temporal distance indicating an amount of time that elapsed between occurrence of statements represented by the first representative vector and the second representative vector; and
including the first representative vector and a second representative vector in the first vector cluster based on the vector distance between the first representative vector and the second representative vector.

5. The method of claim 1, further comprising:
transcribing a captured video, yielding the text.

6. The method of claim 1, wherein the first vector cluster and the second cluster are generated using Hierarchical Agglomerative Clustering(HAC).

7. The method of claim 1, further comprising:
ranking the first subset of representative vectors based on respective tf-idf values corresponding to each representative vector in the first subset of representative vectors, yielding a first ranking;
ranking the second subset of representative vectors based on respective tf-idf values corresponding to each representative vector in the second subset of representative vectors, yielding a second ranking;
determining, based on the first ranking, a first set of statements representing the first vector cluster, wherein at least one representative vector from the first subset of representative vectors corresponds to a statement that is not included in the first set of statements representing the first vector cluster;
determining, based on the second ranking, a second set of statement representing the second vector cluster, wherein at least one representative vector from the second subset of representative vectors corresponds to a statement that is not included in the second set of statements; and
generating a first aggregated set of statements based on the first set of statements representing the first vector cluster and the second set of statement representing the second vector cluster.

8. The method of claim 7, further comprising:
generating a representative vector for each statement from a first aggregated set of statements, yielding set of representative vectors for the first aggregated set of statements; and
determining a topic of the first aggregated set of statements based on the set of representative vectors for the first aggregated set of statements.

9. A system comprising:
one or more computer processors; and
one or more computer-readable mediums storing instructions that, when executed by the one or more computer processors, cause the system to perform operations comprising:
generating a representative vector for each statement from a set of statements in a text, yielding a set of representative vectors for the text, wherein each statement includes one or more terms and each representative vector indicates a relative importance of its respective statement to the text based on the one or more terms included in the respective statement;
generating, based on the representative vectors in the set of representative vectors, at least a first vector cluster and a second vector cluster, the first vector cluster including a first subset of representative vectors from the set of representative vectors and the second vector cluster including a second subset of representative vectors from the set of representative vectors, wherein the first subset of the representative vectors includes at least one representative vector that is not included in the second subset of representative vectors;
determining, based on statements represented by the first subset of representative vectors included in the first vector cluster, a first topic of the text;
determining, based on statements represented by the second subset of representative vectors included in the second vector cluster, a second topic of the text; and
generating a summary of the text based on the first topic and the second topic.

10. The system of claim 9, wherein generating the representative vector for each statement comprises:
determining a term frequency-inverse document frequency (tf-idf) value based on the one or more terms included in the respective statement; and
generating the representative vector based on the tf-idf value.

11. The system of claim 9, wherein determining the first topic comprises:
ranking the first subset of representative vectors based on respective tf-idf values corresponding to each representative vector in the first subset of representative vectors;
selecting a first representative vector from the first subset of representative vectors based on the ranking; and
determining the first topic based on the respective statement corresponding to the first representative vector.

12. The system of claim 9, wherein generating the first vector cluster comprises:
determining a vector distance between at least first representative vector and a second representative vector, the vector distance determined based on a cosine similarity value indicating a determined distance between the first representative vector and the second representative vector and a temporal distance indicating an amount of time that elapsed between occurrence of statements represented by the first representative vector and the second representative vector; and
including the first representative vector and a second representative vector in the first vector cluster based on the vector distance between the first representative vector and the second representative vector.

13. The system of claim 9, the operations further comprising:
transcribing a captured video, yielding the text.

14. The system of claim 9, wherein the first vector cluster and the second cluster are generated using Hierarchical Agglomerative Clustering(HAC).

15. The system of claim 9, the operations further comprising:
ranking the first subset of representative vectors based on respective tf-idf values corresponding to each representative vector in the first subset of representative vectors, yielding a first ranking;
ranking the second subset of representative vectors based on respective tf-idf values corresponding to each representative vector in the second subset of representative vectors, yielding a second ranking;
determining, based on the first ranking, a first set of statements representing the first vector cluster, wherein at least one representative vector from the first subset of representative vectors corresponds to a statement that is not included in the first set of statements representing the first vector cluster;
determining, based on the second ranking, a second set of statement representing the second vector cluster, wherein at least one representative vector from the second subset of representative vectors corresponds to a statement that is not included in the second set of statements; and
generating a first aggregated set of statements based on the first set of statements representing the first vector cluster and the second set of statement representing the second vector cluster.

16. The system of claim 15, the operations further comprising:
generating a representative vector for each statement from a first aggregated set of statements, yielding a set of representative vectors for the first aggregated set of statements; and
determining a topic of the first aggregated set of statements based on the set of representative vectors for the first aggregated set of statements.

17. A non-transitory computer-readable medium storing instructions that, when executed by one or more computer processors of a computing system, cause the computing system to perform operations comprising:
generating a representative vector for each statement from a set of statements in a text, yielding a set of representative vectors for the text, wherein each statement includes one or more terms and each representative vector indicates a relative importance of its respective statement to the text based on the one or more terms included in the respective statement;
generating, based on the representative vectors in the set of representative vectors, at least a first vector cluster and a second vector cluster, the first vector cluster including a first subset of representative vectors from the set of representative vectors and the second vector cluster including a second subset of representative vectors from the set of representative vectors, wherein the first subset of the representative vectors includes at least one representative vector that is not included in the second subset of representative vectors;
determining, based on statements represented by the first subset of representative vectors included in the first vector cluster, a first topic of the text;
determining, based on statements represented by the second subset of representative vectors included in the second vector cluster, a second topic of the text; and
generating a summary of the text based on the first topic and the second topic.

18. The non-transitory computer-readable medium of claim 17, wherein generating the representative vector for each statement comprises:
determining a term frequency-inverse document frequency (tf-idf) value based on the one or more terms included in the respective statement; and
generating the representative vector based on the tf-idf value.

19. The non-transitory computer-readable medium of claim 17, wherein determining the first topic comprises:
ranking the first subset of representative vectors based on respective tf-idf values corresponding to each representative vector in the first subset of representative vectors;
selecting a first representative vector from the first subset of representative vectors based on the ranking; and
determining the first topic based on the respective statement corresponding to the first representative vector.

20. The non-transitory computer-readable medium of claim 17, wherein generating the first vector cluster comprises:
determining a vector distance between at least a first representative vector and a second representative vector, the vector distance determined based on a cosine similarity value indicating a determined distance between the first representative vector and the second representative vector and a temporal distance indicating an amount of time that elapsed between occurrence of statements represented by the first representative vector and the second representative vector; and
including the first representative vector and a second representative vector in the first vector cluster based on the vector distance between the first representative vector and the second representative vector.
